(19) United States
(12) Patent Application Publication
(10) Pub. No.: US 2024/0125673 A1
(43) Pub. Date: Apr. 18, 2024

(54) BLADE DAMAGE EVALUATION SYSTEM, BLADE DAMAGE EVALUATION METHOD, AND BLADE DAMAGE EVALUATION PROGRAM

(71) Applicant: TOSHIBA ENERGY SYSTEMS & SOLUTIONS CORPORATION, Kawasaki-shi Kanagawa (JP)

(72) Inventors: Yasutaka KAWADA, Kawasaki Kanagawa (JP); Yusuke SUZUKI, Yokohama Kanagawa (JP); Shota NAKAJIMA, Yokohama Kanagawa (JP); Yasuteru KAWAI, Yokohama Kanagawa (JP)

(73) Assignee: TOSHIBA ENERGY SYSTEMS & SOLUTIONS CORPORATION, Kawasaki-shi Kanagawa (JP)

(21) Appl. No.: 18/314,189

(22) Filed: May 9, 2023

(30) Foreign Application Priority Data
Oct. 18, 2022 (JP) 2022-166707

(51) Int. Cl. G01M 15/14; F01D 21/00

(52) U.S. Cl. CPC G01M 15/14; F01D 21/003

(57) ABSTRACT

According to one embodiment, a blade damage evaluation system comprising one or more computers configured to: evaluate inflow and collision of solid particles into a turbine based on design data, maintenance data, and operation data; and calculate a survival rate by applying at least one data included in at least one of the design data, the maintenance data, and the operation data as at least one factor to a formula that models the turbine by survival time analysis, the survival rate indicating that erosion amount of at least one of a plurality of blades does not reach a predetermined threshold at arbitrary time in future.

### CROSS-REFERENCE TO RELATED APPLICATION

This application is based upon and claims the benefit of priority from Japanese Patent Application No. 2022-166707, filed on Oct. 18, 2022, the entire contents of which are incorporated herein by reference.

### TECHNICAL FIELD

Embodiments of the present invention relate to a technique for evaluating blade damage.

### BACKGROUND

In a turbine, blades are subjected to a jet of high-temperature and high-pressure steam or gas generated by heating in, for example, a boiler or a combustor so as to obtain driving force and rotate. In this steam or gas, solid particles are mixed. Although a capturing method such as a strainer is provided at an appropriate position such as a steam valve for a purpose of reducing any foreign objects including solid particle that flew into steam valve or steam turbine, it is inevitable that a certain rate of the solid particles flow into the inside of the turbine. When the solid particles mixed in the steam or gas collide with the surfaces of the respective blades, the blades are thinned from the surfaces. This is due to occurrence of SPE (Solid Particle Erosion), i.e., phenomenon in which the surface is eroded or worn by the collision of the solid particles.

In particular, of the blades provided on the turbine rotating shaft in multiple stages, the thickness-loss due to SPE is remarkable in first-stage rotor blades. The thickness-loss amount (i.e., reduction in thickness) of the first-stage rotor blades is managed in such a manner that the thickness-loss amount does not exceed a threshold value determined on the basis of strength evaluation of the blades. In a conventional general management method, the thickness-loss amount is measured at the time of a major inspection of the turbine, and parameters such as a thickness-loss rate are calculated from the thickness-loss amount measured at the previous inspection. On the basis of the relationship between the thickness-loss rate and the threshold value, the time for the next major inspection or the recommended time for blade replacement is estimated.

In the above-described conventional management method, it is required to periodically open the casing of the turbine and measure the thickness-loss amount of the rotor blades, which has a problem that a considerable number of processes and a considerable construction period are required. In recent years, thermal power generation is expected to be operated as adjustable thermal power such as low load operation or variable load operation, unlike the conventional baseload operation. Since the conventional prediction of thickness-loss amount due to SPE is on the premise of the baseload operation, it is difficult to apply the conventional prediction to the prediction of thickness-loss amount due to SPE when the turbine is operated as adjustable thermal power by dynamically changing the operating conditions.

In view of the above-described circumstances, embodiments of the present invention aim to provide a technique for accurately evaluating blade damage of a turbine that is operated under dynamically changing operating conditions.

### BRIEF DESCRIPTION OF THE DRAWINGS

In the accompanying drawings:

FIG. 1 is a block diagram illustrating a blade damage evaluation system;

FIG. 2 is a schematic diagram illustrating a thermal power plant;

FIG. 3 is a flowchart illustrating processing of a blade damage evaluation method;

FIG. 4 is a graph illustrating relationship between a survival rate and time when one factor is taken into consideration; and

FIG. 5 is a graph illustrating the relationship between the survival rate and time when a plurality of factors are taken into consideration.

### DETAILED DESCRIPTION

In one embodiment of the present invention, a blade damage evaluation system comprising one or more computers configured to evaluate damage of a plurality of blades of a turbine that is driven to rotate by a flow of steam or gas, wherein the one or more computers are configured to: acquire design data related to structure and configuration of the turbine and a peripheral component associated with the turbine; acquire maintenance data related to maintenance of the turbine and the peripheral component; acquire operation data related to respective operating states of the turbine and the peripheral component from respective sensors that are provided in the turbine and the peripheral component; evaluate inflow and collision of solid particles into the turbine based on the design data, the maintenance data, and the operation data; and calculate a survival rate by applying at least one data included in at least one of the design data, the maintenance data, and the operation data as at least one factor to a formula that models the turbine by survival time analysis, the survival rate indicating that erosion amount of at least one of the plurality of blades does not reach a predetermined threshold at arbitrary time in future.

According to embodiments of the present invention, it is possible to provide a technique for accurately evaluating blade damage of a turbine that is operated under dynamically changing operating conditions.

Hereinafter, a detailed description will be given of respective embodiments of blade damage evaluation systems, blade damage evaluation methods, and computer-readable blade damage evaluation programs by referring to the accompanying drawings.

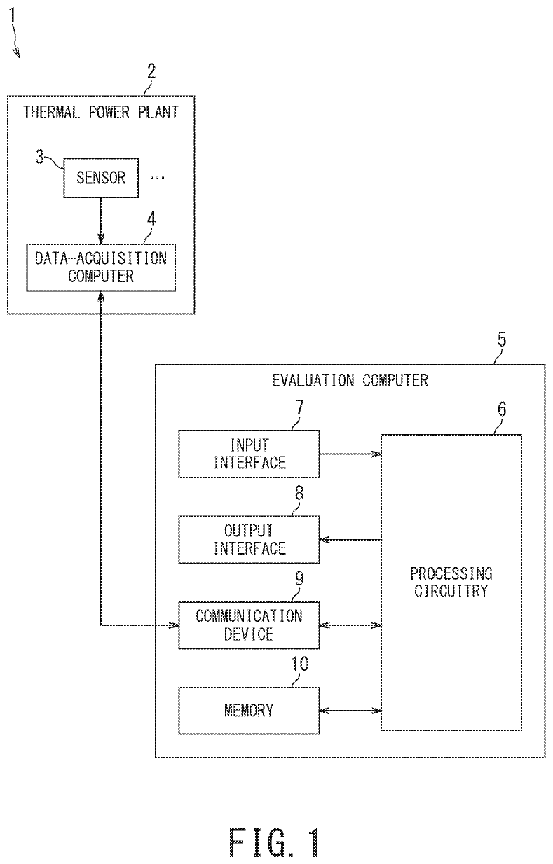

The reference sign 1 in FIG. 1 denotes a blade damage evaluation system of the present embodiment. The blade damage evaluation system 1 evaluates failure and indication of failure of each device or component installed in an evaluation-target facility on the basis of various data acquired from the evaluation-target facility. In particular, the blade damage evaluation system 1 evaluates wear damage (or erosion amount) associated with any power generation facilities. The evaluation-target facility is, for example, a thermal power plant 2. The evaluation-target facility may be a nuclear power plant, a factory or a commercial facility provided with a power generator, for example.

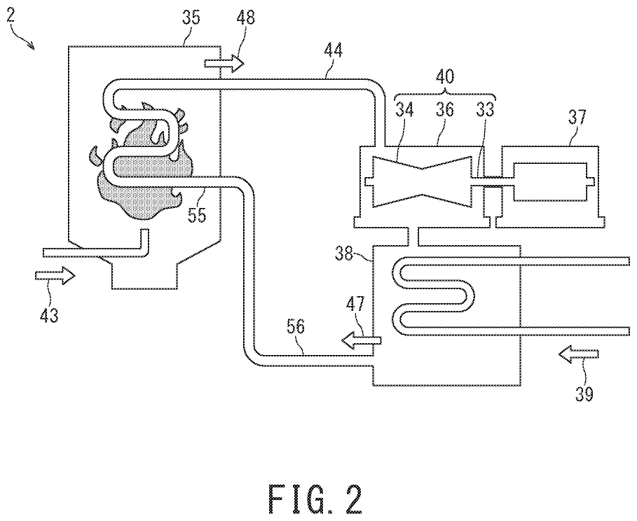

As shown in FIG. 2, the device or component to be evaluated in terms of failure or its indication is, for example, a turbine 40 installed in the thermal power plant 2. The blade damage evaluation system 1 evaluates damage of a plurality of blades 34 of this turbine 40. Although a description will be given of the turbine 40 that is driven to rotate by a flow of steam 48, the turbine 40 may be driven to rotate by the flow of high-temperature and high-pressure gas.

The thermal power plant 2 supplies fuel 43 to the inside of a boiler 35 to burn the fuel 43, and performs heat-exchange by using a heat exchanger 55 so as to gasify a liquid medium 47 into the steam 48. The steam 48 generated by the boiler 35 is led to a main steam pipe 44 and introduced into the turbine 40, and then is injected onto the blades 34 to rotate a rotor 33 supported by a casing 36. The rotor 33 rotationally drives a coaxially connected generator 37 so as to cause the generator 37 to convert rotational kinetic energy into electrical energy.

The steam 48 discharged by working on the turbine 40 is cooled by a steam condenser 38 in which cooling water 39 circulates, and then is condensed to return the liquid medium 47 as a condensed water. The liquid medium 47 is resupplied to the heat exchanger 55 of the boiler 35 via a water supply pipe 56. In the present embodiment, the blades 34 include both of: rotor blades (34) that are radially provided along the radial direction of the rotor 33 and rotate along with the rotor 33; and stator blades (34) that are disposed in the gap of the arrangement of the rotor blades and fixed to the casing 36. Note that a term “peripheral component” of the turbine 40 refers to an arbitrary device or component that is connected to the turbine 40 mechanically or via the steam 48.

The steam 48 sent from the boiler 35 to the turbine 40 is mixed with a large amount of liberated solid particles that are generated by being separated from the oxide film (scale) generated mainly on the interior surface of the heat exchanger 55. Such solid particles collide with the blades 34, and consequently, the blades 34 of the turbine 40 undergo erosion called SPE (Solid Particle Erosion).

When the blades 34 are eroded (i.e., worn) and damaged by the collision with the solid particles contained in the steam 48, the injection conditions (such as the angle and speed) of the steam 48 to be injected from the stator blades to the rotor blades change and the internal efficiency (i.e., performance) of the turbine 40 is reduced. As the erosion (i.e., wear) progresses further, damage such as breakage and bent of the blades 34 develops. Further, it is conceivable that cracks develop and grow in a blade 34 and this blade 34 is blown away so as to collide with another normal blade 34 and damage it.

Thus, in the thermal power plant 2, consideration is given in design, maintenance, and operation to prevent the introduction of solid particles of scale from the boiler 35 in operation to the turbine 40. However, it is not possible to completely prevent such mixture of the solid particles into the steam 48. Thus, it is necessary to accurately monitor and predict the progress of the damage in the blades 34 due to SPE.

Next, the configuration of the blade damage evaluation system 1 will be described by referring to the block diagram of FIG. 1.

First, the thermal power plant 2 is provided with many sensors 3. These sensors 3 are, for example, predetermined measuring instruments attached to the turbine 40 and its peripheral components. In addition, the sensors 3 acquire measured values (i.e., actually measured values) that include information indicating the respective states of the turbine 40 and the peripheral components.

The blade damage evaluation system 1 of the present embodiment includes a data-acquisition computer 4 and an evaluation computer 5. These include hardware resources such as a Central Processing Unit (CPU), a Graphics Processing Unit (GPU), a Read Only Memory (ROM), a Random Access Memory (RAM), a Hard Disc Drive (HDD), and a Solid State Drive (SSD), and are configured computers in which information processing by software is achieved with the use of the hardware resources by causing the CPU to execute various programs. Further, the blade damage evaluation method of the present embodiment is achieved by causing the computers to execute the various programs.

The data-acquisition computer 4 is installed in the thermal power plant 2 and acquires operation data acquired by the sensors 3. The data-acquisition computer 4 is, for example, a server for storing the operation data. The acquired operation data are sent to the evaluation computer 5.

The evaluation computer 5 performs damage evaluation of the blades 34 of the turbine 40. The evaluation computer 5 evaluates both the rotor blades and the stator blades in each of a first stage, a middle stage, and a rear stage in the turbine 40, for example.

The evaluation computer 5 includes: processing circuitry 6; an input interface 7; an output interface 8; a communication device 9; and a memory 10.

The processing circuitry 6 of the present embodiment is, for example, a circuit provided with the CPU and/or a special-purpose or general-purpose processor. The processor implements various functions by executing programs stored in the memory 10. The processing circuitry 6 may be configured of hardware such as a field programmable gate array (FPGA) and an application specific integrated circuit (ASIC). The various functions can also be implemented by such hardware. Additionally, the processing circuitry 6 can implement the various functions by combining hardware processing and software processing based on its processor and programs.

Predetermined information is inputted to the input interface 7 in response to an operation by a user who uses the evaluation computer 5. The input interface 7 includes an input device such as a mouse and a keyboard. That is, the predetermined information is inputted to the input interface 7 depending on the operation on these input devices.

The output interface 8 outputs the predetermined information. The evaluation computer 5 includes a device that displays an image such as a display that outputs analysis results. This output interface 8 controls images to be displayed on the display. The display may be separated from a main body of the computer or may be integrated with the main body of the computer.

The communication device 9 performs communication with the data-acquisition computer 4 via a predetermined communication line. In the present embodiment, the data-acquisition computer 4 and the evaluation computer 5 are interconnected via a Local Area Network (LAN). The data-acquisition computer 4 and the evaluation computer 5 may be interconnected via the Internet, a Wide Area Network (WAN), or a mobile communication network.

The memory 10 stores various information items necessary for evaluating the blades 34 (FIG. 2). For example, the memory 10 stores the operation data sent from the data-acquisition computer 4. In addition, the memory 10 stores maintenance data and design data, both of which are acquired in advance.

Further, the evaluation computer 5 may include configurations excluding the components shown in FIG. 1 or one or more components of the evaluation computer 5 shown in FIG. 1 may be omitted.

Moreover, each configuration of the evaluation computer 5 does not necessarily have to be provided in one computer. For example, the configuration of the evaluation computer 5 may be achieved by a plurality of computers that are interconnected via a network. In this case, the memory 10 for storing the design data, the maintenance data, and the operation data may be provided in each of the databases that are configured as such interconnected computers, for example.

As shown in FIG. 2, the design data include design information on structure and configuration related to the turbine 40 and its peripheral components. The peripheral components include, for example, the boiler 35, the power generator 37, the steam condenser 38, the main steam pipe 44, the heat exchanger 55, the water supply pipe 56, a steam valve (not shown), and a bypass valve (not shown).

The design data are mainly composed of one or more of: plant design conditions; boiler design conditions; piping design conditions; steam-valve design conditions; and turbine design conditions.

The design data include at least one of: the design information of the thermal power plant 2 in which the turbine 40 is provided; the design information of the boiler 35 or the heat exchanger 55; the design information of the main steam pipe 44 or the water supply pipe 56; the design information of the steam valve (not shown); and the design information of the turbine 40.

The design information of the thermal power plant 2 includes at least one of: power generation capacity; and information as to whether the thermal power plant 2 is a combined-cycle power plant or a conventional power plant.

The design information of the boiler 35 or the heat exchanger 55 includes at least one of: temperature during the rated operation; pressure during a rated operation; fuel type; model; capacity; and a material of a tube (not shown) of the heat exchanger 55.

The design information of the main steam pipe 44 or the water supply pipe 56 includes at least one of: a material of the main steam pipe 44 or the water supply pipe 56; length of the main steam pipe 44 or the water supply pipe 56; exposure temperature of the main steam pipe 44 or the water supply pipe 56; and information on presence/absence of a bypass flow passage (not shown) for the main steam pipe 44 or the water supply pipe 56.

The design information of the steam valve (not shown) includes at least one of: information on presence/absence of a fine mesh (not shown); and information on presence/absence of an auxiliary valve (not shown).

The design information of the turbine 40 includes at least one of: temperature of the steam. 48 to be injected into the turbine 40; flow rate of this steam 48; pressure of this steam 48; number of admissions; number of the blades 34 as the rotor blades; blade length; rotor blades-stator blades distance; Pitch Circle Diameter (PCD); rotational circumferential speed; number of the blades 34 as the stator blades; an outflow angle; and blade strength characteristics.

The maintenance data are mainly composed of one or more of: boiler maintenance data; piping maintenance data; and turbine maintenance data.

The maintenance data include at least one of: the maintenance information of the boiler 35 or the heat exchanger 55; the maintenance information of the main steam pipe 44 or the water supply pipe 56; and the maintenance information of the turbine 40. In other words, the maintenance data include information on a work history that contributes to reduction in the solid particles to be entrained in the steam 48.

The maintenance information of the boiler 35 or the heat exchanger 55 includes at least one of: number of maintenance times; frequency of maintenance; maintenance timing; a descaling method; a flushing method; and information as to whether the tube (not shown) of the heat exchanger 55 has been replaced or not.

The maintenance information of the main steam pipe 44 or the water supply pipe 56 includes at least one of: number of maintenance times; frequency of maintenance; maintenance timing; a descaling method; and a flushing method.

The maintenance information of the turbine 40 includes at least one of: number of maintenance times; frequency of maintenance; maintenance timing; a replacement history of the first-stage rotor blades or the first-stage stator blades; and a maintenance history of the first-stage rotor blades or the first-stage stator blades.

The operation data are data to be obtained from the sensors 3 attached to the respective components of the thermal power plant 2. The operation data are primarily temporal data indicating the operating state that is considered to have influence on inflow and collision of solid particles. For example, the operation data include: the steam conditions before and after the first-stage rotor blades or the first-stage stator blades; an opening degree of the steam valve (not shown); and an opening degree of the bypass valve (not shown). The operation data may be temporal data of other upstream components that have influence on downstream components in the flow of the steam 48, such as operating conditions of the boiler 35.

Evaluation of the operating state related to inflow and collision of solid particles into the turbine 40 based on the operation data is similar to the evaluation of structure and configuration, but differs in terms of further evaluating change in inflow and collision of solid particles with respect to the operating state having changed from the design time. For example, a steam outflow rate of the stator blades changes when an amount of steam flowing into the turbine 40 fluctuates due to change in opening degree of the steam valve (not shown). Thus, collision conditions of the steam 48 containing the solid particles are evaluated sequentially on the basis of the steam outflow rate.

The operation data include at least one of: conditions including temperature, flow rate, and pressure of the steam 48 before and after the first-stage rotor blades or the first-stage stator blades in the turbine 40; the opening degree of the steam valve (not shown); the opening degree of the bypass valve (not shown); and number of a cold starting and stopping as number of a set of operation of stopping the turbine 40 to a cold state and restarting the turbine 40 from the cold state.

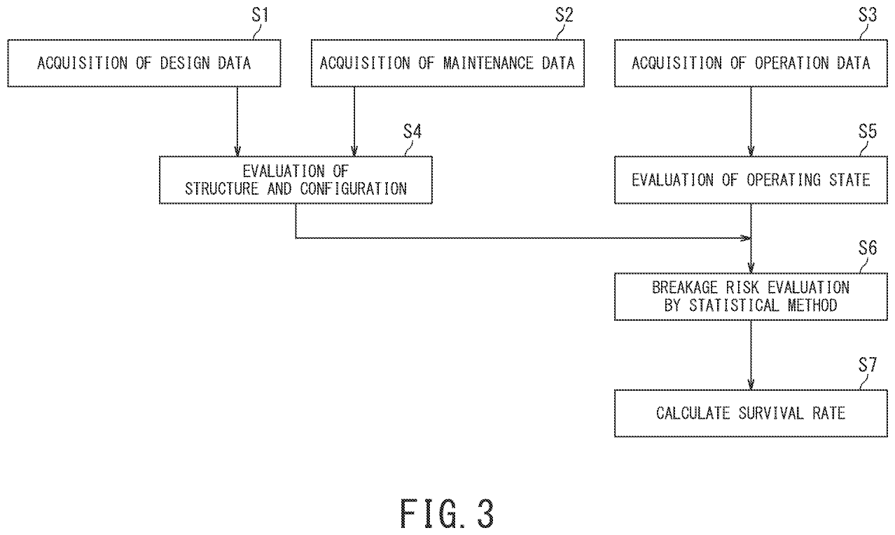

Next, a description will be given of the processing to be executed by the evaluation computer 5 on the basis of the flowchart of FIG. 3 by referring to the above-described FIG. 1 and FIG. 2 as required. The following steps are at least part of the processing to be executed by the evaluation computer 5, and other steps may be included in the processing to be executed by the evaluation computer 5.

Each arrow in FIG. 3 is only one interpretation for illustrating the flow of the processing, and a flow of processing excluding the arrows in FIG. 3 may be included. Further, the anteroposterior relationship of the respective steps is not necessarily fixed, and the anteroposterior relationship of one or more steps may be replaced or changed. Moreover, two or more of the steps may be executed in parallel with each other.

In the step S1, the evaluation computer 5 acquires the design data on structure and configuration of the turbine 40 and its peripheral components. The design data may be inputted from the input interface 7 or may be acquired from another computer (not shown) via the communication device 9. The acquired design data are stored in the memory 10, and then the processing proceeds to the step S4.

In the step S2, the evaluation computer 5 acquires the maintenance data on the maintenance of the turbine 40 and its peripheral components. The maintenance data may be inputted from the input interface 7 or may be acquired from another computer (not shown) via the communication device 9. The acquired maintenance data are stored in the memory 10, and then the processing proceeds to the step S4.

In the step S3, the evaluation computer 5 acquires the operation data on the respective operating states of the turbine 40 and its peripheral components from the respective sensors 3 provided in the turbine 40 and the peripheral components via the data-acquisition computer 4. The acquired operation data are stored in the memory 10, and then the processing proceeds to the step S5.

In the step S4, the evaluation computer 5 performs evaluation of the structure and configuration related to inflow and collision of solid particles into the turbine 40 on the basis of the design data and the maintenance data, and then the processing proceeds to the step S6.

On the basis of the correlation between the acquired SPE erosion data of the thermal power plant 2 in actual operation and the configuration or design data of each component, the evaluation computer 5 performs the evaluation of the structure and configuration related to inflow conditions of solid particles into the turbine 40 by using estimated level of inflow amount of solid particle. For example, the evaluation computer 5 uses magnitude relationship of the inflow amount of solid particles at the time of startup depending on presence/absence of the bypass flow passage (not shown) so as to evaluate the inflow conditions of solid particle into the turbine 40 of the thermal power plant 2 to be evaluated.

For the evaluation of the structure and configuration related to inflow conditions of solid particles into the turbine 40, the evaluation computer 5 uses the collision conditions of solid particles that are estimated on the basis of the correlation between the acquired SPE erosion data of the thermal power plant 2 in actual operation and the maintenance data of the respective components. For example, the collision conditions of solid particles into the turbine 40 of the thermal power plant 2 are evaluated by using: the steam outflow angle of the stator blades; steam outflow rate of the stator blades; circumferential speed of the rotor blades; and a calculated collision angle between the blades 34 and the steam 48 mixed with solid particles.

In the step S5, the evaluation computer 5 evaluates the operating state related to the inflow and collision of solid particles into the turbine 40 on the basis of the operation data, and then the processing proceeds to the step S6.

In the step S6, the evaluation computer 5 performs breakage risk evaluation of the blades 34 by a statistical method on the basis of: the above-described evaluation of the structure and configuration; and the above-described evaluation of the operating state, and then the processing proceeds to the step S7.

In the step S7, the evaluation computer 5 calculates a survival rate indicating that the erosion amount of at least one blade 34 of the plurality of blades 34 does not reach a predetermined threshold at arbitrary time in the future. The survival rate is the probability of not reaching the erosion threshold for the at least one blade 34. In this manner, the damage of the at least one blade 34 can be evaluated. Note that a plurality of survival rates is calculated for the respective blades 34 or respective groups of a predetermined number of blades 34, for example.

The evaluation computer 5 calculates the survival rate by applying at least one data included in at least one of the design data, the maintenance data, and the operation data as a factor to a formula that models the turbine 40 by survival time analysis.

The survival time analysis is analysis in which the time length from a certain reference time point to the occurrence of an event as a target. The event is that the erosion amount of the at least one blade 34 reaches the threshold. For example, the analysis target is the time length until the erosion amount of the at least one blade 34 currently in operation reaches the threshold of 3 mm. Note that this threshold can be set to any value by a turbine designer in consideration of the occurrence of the event, for example.

The erosion amount of the at least one blade 34 is evaluated by using: the survival rate R of the at least one blade 34 by SPE; and at least one factor X that has influence on the survival rate R, and the relationship between the survival rate R and the factor X is expressed by the following formula. The factors X (X1, X2, X3, . . . Xn) are data included in the operation data, the design data, and the maintenance data. The function f is a survival function modeled by survival time analysis.

R=f(X1,X2,X3, . . . Xn)

The above-described formula can reflect that the operation data, the design data, and the maintenance data have influence on the survival rate R. In addition, a constant term may be added to the right-hand side of the above-described formula for reflecting the magnitude of the influence of certain data included in these three data.

In the above-described formula, the constant term as a factor capable of reflecting the magnitude of the influence of certain data and its influence degree is determined by the user on the basis of: the erosion threshold having been set by the user in advance; the acquired operation data; the acquired design data; and the acquired maintenance data, for example. Further, the user may freely configure the form of the above-described formula as appropriate on the basis of the user's own judgment.

The field data to be used by the user for judgment desirably include not only the data for the cases where the erosion reaches the threshold but also the data for the cases where the erosion does not reach the threshold. Further, the above-described formula is derived by using a statistical technique with data.

For example, the formula that models the turbine 40 by survival time analysis is derived by using the field data of the blades 34 having reached the threshold and the field data of the blades 34 that have not reached the threshold. In this manner, the formula that models the turbine 40 can be derived by using a statistical method.

Note that the field data include field data of the respective blades 34 in each of a plurality of turbines 40. In addition, the field data include field data obtained from a plurality of thermal power plants 2.

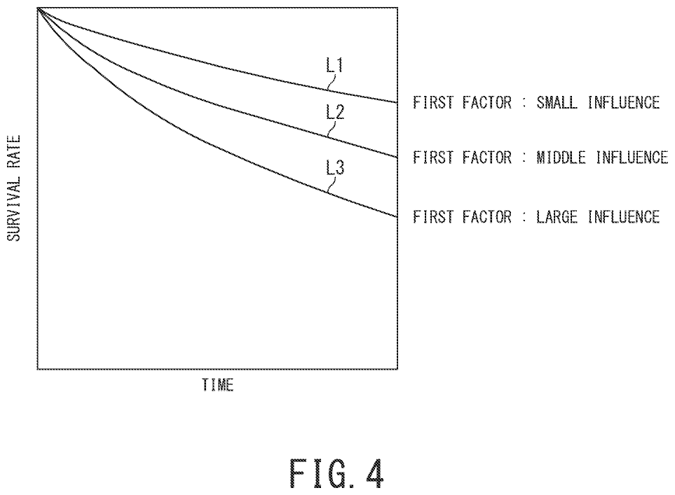

The graph of FIG. 4 shows the relationship between the survival rate and time under the assumption that only the first factor influences the survival rate. For example, the blade 34 of the line L1 is less influenced by (i.e., less susceptible to) the first factor, the blade 34 of the line L2 is influenced by the first factor to an almost average extent, and the blade 34 of the line L3 is largely influenced by the first factor.

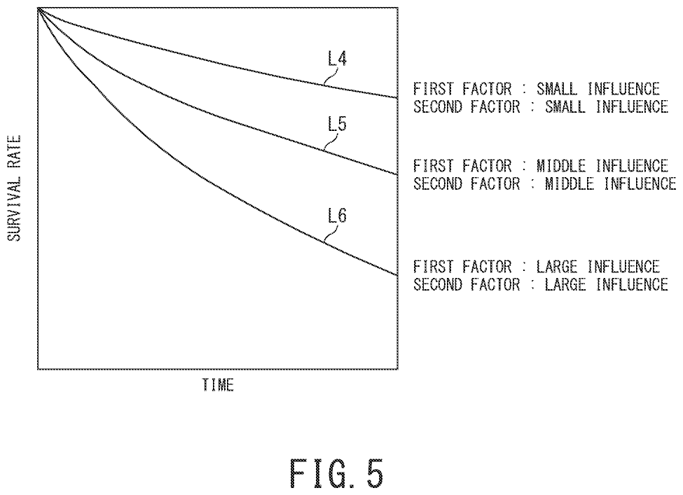

The graph of FIG. 5 shows the relationship between the survival rate and time under the assumption that only the first factor and the second factor influence the survival rate. For example, the blade 34 of the line L4 is less influenced by the first and second factors, the blade 34 of the line L5 is influenced by the first and second factors to an almost average extent, and the blade 34 of the line L6 is largely influenced by the first and second factors. The survival rate at a certain time point can be estimated by inputting some data. In other words, the estimation accuracy of the survival rate can be improved by applying at least two (plural) data as factors to the above-described formula and thereby calculating the survival rate.

In addition, the formula modeling the turbine 40 by survival time analysis is derived by using, for example, a Cox proportional hazard model. In this manner, the influence of various data on the event that occurs due to elapse of time can be statistically analyzed.

The Cox proportional hazard model is one of the non-parametric methods for survival time analysis, and is a model on the premise of analyzing the influence of covariates as a plurality of factors that have influence on the event.

The above-described evaluation computer 5 may calculate the erosion amount of each blade 34 on the basis of each calculated survival rate.

The evaluation computer 5 may evaluate recommend replacement time of each blade 34 on the basis of each calculated survival rate.

The evaluation computer 5 may acquire the operation data not only on the basis of the operation data acquired by the sensors 3 but also on the basis of the operating state that is simulated in accordance with a future operation plan.

The blade damage evaluation system 1 in the present embodiment includes a storage device such as the ROM and the RAM, an external storage device such as the HDD and the SSD, a display device such as a display panel, the input device such as the mouse and the keyboard, the communication device, and a control device which has a highly integrated processor such as the FPGA, the CPU, the GPU, and a special-purpose chip. The blade damage evaluation system 1 can be achieved by hardware configuration with the use of the normal computer.

Note that each program executed in the blade damage evaluation system 1 of the present embodiment is provided by being incorporated in a memory such as the ROM in advance. Additionally or alternatively, each program may be provided by being stored as a file of installable or executable format in a non-transitory computer-readable storage medium such as a CD-ROM, a CD-R, a memory card, a DVD, and a flexible disk (FD).

In addition, each program executed in the blade damage evaluation system 1 may be stored on a computer connected to a network such as the Internet and be provided by being downloaded via a network. Further, the blade damage evaluation system 1 can also be configured by interconnecting and combining separate modules, which independently exhibit respective functions of the components, via a network or a dedicated line.

According to the embodiments described above, damage to each blade 34 of the turbine 40 to be operated under dynamically changing operating conditions can be accurately evaluated by calculating each survival rate.

Although a description is given for the case of the steam turbine in the embodiments, the present invention can be applied to gas turbines and other types of turbines.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions. The articles “the”, “a” and “an” are not necessarily limited to meaning only one, but rather are inclusive and open ended so as to include, optionally, multiple such elements.

What is claimed is:

1. A blade damage evaluation system comprising one or more computers configured to evaluate damage of a plurality of blades of a turbine that is driven to rotate by a flow of steam or gas,
wherein the one or more computers are configured to:
acquire design data related to structure and configuration of the turbine and a peripheral component associated with the turbine;
acquire maintenance data related to maintenance of the turbine and the peripheral component;
acquire operation data related to respective operating states of the turbine and the peripheral component from respective sensors that are provided in the turbine and the peripheral component;
evaluate inflow and collision of solid particles into the turbine based on the design data, the maintenance data, and the operation data; and
calculate a survival rate by applying at least one data included in at least one of the design data, the maintenance data, and the operation data as at least one factor to a formula that models the turbine by survival time analysis, the survival rate indicating that erosion amount of at least one of the plurality of blades does not reach a predetermined threshold at arbitrary time in future.

2. The blade damage evaluation system according to claim 1, wherein the one or more computers are configured to calculate the survival rate by applying at least two data included in at least one of the design data, the maintenance data, and the operation data as at least two factors to the formula.

3. The blade damage evaluation system according to claim 1, wherein:
the design data include at least one of design information of a power plant provided with the turbine, design information of a boiler or a heat exchanger as the peripheral component, design information of a main steam pipe or a water supply pipe as the peripheral component, design information of a steam valve as the peripheral component, and design information of the turbine;
the design information of the power plant includes at least one of power generation capacity and information as to whether the power plant is a combined-cycle power plant or a conventional power plant;
the design information of the boiler or the heat exchanger includes at least one of temperature during rated operation, pressure during the rated operation, fuel type, model, capacity, and a material of a tube of the heat exchanger;
the design information of the main steam pipe or the water supply pipe includes at least one of a material of the main steam pipe or the water supply pipe, length of the main steam pipe or the water supply pipe, exposure temperature of the main steam pipe or the water supply pipe, and information on presence/absence of a bypass flow passage for the main steam pipe or the water supply pipe;
the design information of the steam valve includes at least one of information on presence/absence of a fine mesh and information on presence/absence of an auxiliary valve; and
the design information of the turbine includes at least one of temperature of the steam to be injected into the turbine, flow rate of the steam to be injected into the turbine, pressure of the steam to be injected into the turbine, number of admissions, number of the plurality of blades as rotor blades; blade length, rotor blades-stator blades distance, pitch circle diameter, rotational circumferential speed; number of the plurality of blades as stator blades; an outflow angle, and blade strength characteristics.

4. The blade damage evaluation system according to claim 1, wherein:
the maintenance data include at least one of maintenance information of a boiler or a heat exchanger as the peripheral component, maintenance information of a main steam pipe or a water supply pipe as the peripheral component, and maintenance information of the turbine;
the maintenance information of the boiler or the heat exchanger includes at least one of number of maintenance time, frequency of maintenance, maintenance timing, a descaling method, a flushing method, and information as to whether a tube of the heat exchanger has been replaced or not;
the maintenance information of the main steam pipe or the water supply pipe includes at least one of number of maintenance times, frequency of maintenance, maintenance timing, a descaling method, and a flushing method; and
the maintenance information of the turbine includes at least one of number of maintenance times, frequency of maintenance, maintenance timing, a replacement history of first-stage rotor blades or first-stage stator blades; and a maintenance history of the first-stage rotor blades or the first-stage stator blades.

5. The blade damage evaluation system according to claim 1, wherein:
the operation data include at least one of conditions including temperature, flow rate, and pressure of the steam before and after first-stage rotor blades or first-stage stator blades in the turbine; opening degree of a steam valve as the peripheral component; opening degree of a bypass valve as the peripheral component; and number of a cold starting and stopping.

6. The blade damage evaluation system according to claim 1, wherein the formula is derived by using: field data of at least one of the plurality of blades having reached the threshold; and field data of at least one of the plurality of blades that have not reached the threshold.

7. The blade damage evaluation system according to claim 1, wherein the formula is derived from a Cox proportional hazard model.

8. A blade damage evaluation method of causing one or more computers to evaluate damage of a plurality of blades of a turbine that is driven to rotate by a flow of steam or gas,
the blade damage evaluation method comprising steps of:
acquiring design data related to structure and configuration of the turbine and a peripheral component associated with the turbine;
acquiring maintenance data related to maintenance of the turbine and the peripheral component;
acquiring operation data related to respective operating states of the turbine and the peripheral component from respective sensors that are provided in the turbine and the peripheral component;
evaluating inflow and collision of solid particles into the turbine based on the design data, the maintenance data, and the operation data; and
calculating a survival rate by applying at least one data included in at least one of the design data, the maintenance data, and the operation data as at least one factor to a formula that models the turbine by survival time analysis, the survival rate indicating that erosion amount of at least one of the plurality of blades does not reach a predetermined threshold at arbitrary time in future.

9. A non-transitory computer-readable medium storing a blade damage evaluation program to be executed by one or more computers that evaluates damage of a plurality of blades of a turbine to be driven to rotate by a flow of steam or gas,
the blade damage evaluation program allows the one or more computers to perform:
acquisition of design data related to structure and configuration of the turbine and a peripheral component associated with the turbine;
acquisition of maintenance data related to maintenance of the turbine and the peripheral component;
acquisition of operation data related to respective operating states of the turbine and the peripheral component from respective sensors that are provided in the turbine and the peripheral component;
evaluation of inflow and collision of solid particles into the turbine based on the design data, the maintenance data, and the operation data; and
calculation of a survival rate by applying at least one data included in at least one of the design data, the maintenance data, and the operation data as at least one factor to a formula that models the turbine by survival time analysis, the survival rate indicating that erosion amount of at least one of the plurality of blades does not reach a predetermined threshold at arbitrary time in future.
